(19) United States
(12) Patent Application Publication
(10) Pub. No.: US 2025/0304179 A1
(43) Pub. Date: Oct. 2, 2025

(54) Body Structure for a Body of a Passenger Motor Car, Body and Passenger Motor Car

(71) Applicant: Bayerische Motoren Werke Aktiengesellshaft, Muenchen (DE)

(72) Inventors: Christian HASLAUER, Starnberg (DE); Juergen LESCHHORN, Geltendorf (DE); Marco PARISI, Muenchen (DE)

(21) Appl. No.: 18/865,554

(22) PCT Filed: Apr. 26, 2023
(86) PCT No.: PCT/EP2023/060873

§ 371 Date: Nov. 13, 2024

(30) Foreign Application Priority Data
May 24, 2022 (DE) 10 2022 113 070.3

(51) Int. Cl. B62D 25/02; B62D 21/15; B62D 29/00

(52) U.S. Cl. CPC B62D 25/025; B62D 21/157; B62D 29/008

(57) ABSTRACT

A body structure for a body of a passenger motor car includes two longitudinal beams which are spaced apart from one another in the vehicle transverse direction and are formed as cast light metal parts, at least one crossmember which is formed from a first steel, and a steel structure which is formed from a second steel different from the first steel. The steel structure is connected to the respective longitudinal beams and to the crossmember, as a result of which the respective longitudinal beam is connected via the steel structure to the crossmember.

### BACKGROUND AND SUMMARY

The invention relates to a body structure for an, in particular, unitary body of a passenger motor car. Furthermore, the invention relates to an, in particular, unitary body for a passenger motor car. The invention also relates to a passenger motor car having such a body.

A vehicle body superstructure having a body reinforcement behind a second row of seats can be derived from EP 2 483 136 B1, wherein the body reinforcement consists of a support assembly. Furthermore, DE 10 2010 008 615 B4 discloses a structural node for a body of a vehicle. Moreover, a crossmember for a rear structure of a passenger motor car is known from DE 10 2010 021 142 A1. Furthermore, WO 2022/031991 A1 discloses an integrated energy absorption system for a vehicle.

It is an object of the present invention to achieve a body structure for a body of a passenger motor car, a body for a passenger motor car, and a passenger motor car, so that a particularly advantageous behavior during an accident can be implemented.

This object is achieved according to the invention by a body structure, by a body, and by a passenger motor car having the body structure, in accordance with the independent claim(s). Advantageous design embodiments of the invention are the subject matter of the dependent claims.

A first aspect of the invention relates to a body structure for an, in particular, unitary body of a passenger motor car, also referred to as a vehicle. This means that the passenger motor car in its completely built state has the body which forms or delimits an interior of the passenger motor car, also referred to as the passenger cabin or passenger space. People such as, for example, a driver of the passenger motor car, also simply referred to as a motor car or motor vehicle, can be present in the interior while the passenger motor car is being driven. In its completely built state, the body comprises the body structure which is thus a fixed constituent part of the body that cannot be released in a non-destructive manner. In particular, the body structure is an, in particular, rear sub-structure which in the vehicle height direction of the passenger motor car is disposed further down than the interior, or further below the latter, respectively. The vehicle height direction is also identified as z, or as z-direction.

The body structure has two longitudinal beams which are mutually spaced apart in the vehicle transverse direction of the passenger motor car, wherein the vehicle transverse direction extends perpendicularly to the vehicle height direction and is also identified as y, or as y-direction. The longitudinal beams, the respective directions of longitudinal extent thereof extending at least substantially parallel to the vehicle longitudinal direction of the passenger motor car and being mutually spaced apart in the vehicle transverse direction, are formed as light metal castings. The vehicle longitudinal direction herein extends perpendicularly to the vehicle height direction and perpendicularly to the vehicle transverse direction and is also identified as x, or as x-direction. The feature that the longitudinal beams are formed as light metal castings, which are also referred to as light metal cast components, is understood to mean that the respective longitudinal beam is formed, i.e. produced, as a respective casting and from a respective light metal, i.e. from a respective light metal alloy. Again in other words: the respective longitudinal beam is produced from a light metal, i.e. from a light metal alloy, and is produced by casting, i.e. by a casting method.

The body structure moreover has at least one crossmember by way of which the longitudinal beams are connected to one another, as will yet be explained in more detail hereunder, in particular in that the crossmember is at least indirectly linked to the longitudinal beams. The crossmember is formed from a first steel which is also referred to as a first steel material, and is a first material which is different from the light metal, or the light metal alloy, from which the longitudinal beams are formed. The crossmember has a direction of longitudinal extent which extends at least substantially parallel to the vehicle transverse direction and thus perpendicularly to the respective direction of longitudinal extent of the respective longitudinal beam. It is provided in particular that the longitudinal beams and the crossmember, in particular when viewed in the vehicle height direction, are disposed at the same height, or in a common plane which extends in particular perpendicularly to the vehicle height direction and in the process is defined in particular by the vehicle longitudinal direction and the vehicle transverse direction.

The body structure moreover has a steel structure which could in principle be integrally formed, i.e. be formed by a single piece. However, it is furthermore contemplated that the steel structure is formed in multiple parts and thus has, for example, a plurality of parts, i.e. at least two parts, which are formed separately from one another and are at least indirectly connected to one another. The steel structure is formed, i.e. produced, from a second steel, wherein the second steel is also referred to as a second steel material. The first steel and the second steel are mutually different steels, i.e. mutually different steel materials. In other words: the second steel is a second material which is different from the first steel and from the light metal, or the light metal alloy, from which the longitudinal beams are formed, i.e. produced. It is thus contemplated in particular that the above-mentioned parts of the steel structure are formed from the second steel, consequently from the second steel material. In the context of the present disclosure, a steel, and thus the first steel and the second steel, is/are understood to be in particular an iron/carbon alloy having a proportion of carbon of at most 2 percent by mass, in particular of less than 2 percent by mass.

In the body structure, the steel structure is connected to the respective longitudinal beams and to the crossmember, as a result of which the respective longitudinal beam is connected to the crossmember by way of the steel structure. As a result the longitudinal beams are in particular connected to one another by way of the steel structure and by way of the crossmember. It is provided in particular that the steel structure is connected to a first one of the longitudinal beams at at least one first connection point, in particular by means of a first connecting element and/or by a first joining operation, and connected to the second longitudinal beam at at least one second joining point, in particular by means of at least one second joining element and/or by a second joining operation, wherein the second joining point is spaced apart from the first joining point and provided in addition to the first joining point. Moreover, for example, the steel structure is connected, i.e. joined, to the crossmember at at least one third joining point, in particular by means of at least one third joining element and/or a third joining operation, wherein the third joining point is spaced apart from the first joining point and from the second joining point and provided in addition to the first joining point and in addition to the second joining point. Furthermore, for example, it is provided that the steel structure is connected, i.e. joined, to the crossmember at at least one fourth joining point, in particular by means of at least one fourth joining element and/or by a fourth joining operation, wherein the fourth joining point is spaced apart from the first joining point, from the second joining point and from the third joining point and provided in addition to the first joining point, in addition to the second joining point and in addition to the third joining point. Owing to the fact that the longitudinal beams are connected to the steel structure, and the steel structure is connected to the crossmember, the longitudinal beams are connected to the crossmember, i.e. linked to the crossmember, by way of the intervening steel structure, as a result of which a particularly advantageous linking of the longitudinal beams to the crossmember, or vice versa, can be implemented, in particular despite the use of the light metal, or the light metal alloy, from which the longitudinal beams are produced, and of the first steel from which the crossmember is formed, i.e. produced. At the same time, a particularly favorable behavior of the body structure, and thus of the body and of the passenger motor car overall, during an accident can be implemented by using the light metal, or the light metal alloy, and the first steel, in particular owing to the fact that in the event of an impingement by a force caused by an accident and resulting from a side impact, for example, and thus acting on the body structure in the vehicle transverse direction from the outside toward the inside, for example, a particularly favorable deformation behavior and/or energy absorption capability of the body structure can be implemented. In particular a deformation and/or failure behavior of the body structure in the event of an impingement by a force caused by an accident can be set in a targeted manner by using the first steel, in particular with a view to an arbitrary or unforeseeable failure of the body structure resulting from an impingement by a force caused by an accident, i.e. a failure of the body structure resulting from an impingement by a force caused by an accident, at an unforeseeable location being able to be avoided, and the probability of the latter being able to be kept particularly low.

The invention is in particular based on the following knowledge and concepts. In order to be able to implement an advantageous behavior in the event of an accident, and in the process for example to be able to implement in particular an advantageous side impact protection, stable load paths in particular in the vehicle longitudinal direction and the vehicle transverse direction are advantageous, wherein forces or loads caused by an accident can be advantageously guided by way of the load paths in the event of an impingement of the body structure by a force caused by an accident, these forces or loads being able to be directed around at least one region and thus being able to be kept away from the region, for example. In this way, a construction element can be positioned in the region, for example, which in the event of an accident can be protected by means of the body structure against excessive loads caused by an accident. The construction element is, for example, an electric energy store, in particular when the passenger motor car is designed as an electric vehicle, in particular as a battery-powered electric vehicle. In the completely built state of the passenger motor car, the electric energy store is linked to the longitudinal and/or transverse structures of the body, in particular of the body structure, for example, and by means of the body structure can be advantageously protected against excessive loads caused by an accident, for example, in particular owing to the fact, for example, that the energy store in the state disposed on the body and thus fastened thereto, and thus in the completely built state of the passenger motor car, in the vehicle longitudinal direction toward the front is at least partially overlapped and thus obscured by the crossmember, and/or in the vehicle transverse direction toward the outside is in each case at least partially overlapped and thus obscured on both sides by the respective longitudinal beams of the body structure. For reasons of lightweight construction it is in principle desirable, for example, to produce the rear longitudinal beams in the completely built state of the passenger motor car from the light metal alloy mentioned, so as to keep the weight of the body structure low. In order to implement an advantageous protection of the construction element, such as of the electric energy store, for example, it is furthermore desirable to form, i.e. produce, the crossmember from steel, consequently from the first steel mentioned. However, it has been found that for example when a steel with a very high tensile strength, and in particular a high-tensile steel, for example, is used as the first steel, an advantageous protection of the construction element can indeed be implemented, but a direct connection between the crossmember produced from the first steel and the respective longitudinal beam, formed as a light metal casting, cannot be performed, or can be performed only with great complexity, by riveting, for example, in particular due to an unfavorable strength of a rivet point in such a material combination of the first steel and the light metal, or the light metal alloy, the latter being a light metal casting alloy. The first steel, or the use thereof, is however particularly advantageous with a view to implementing a high degree of side impact protection, because loads caused by an accident can advantageously be transmitted in the vehicle transverse direction by way of the crossmember formed from the first steel, so as thereby to protect the construction element for example against excessive loads which are caused by an accident and act in the vehicle transverse direction.

In order to avoid the above-mentioned issues, the crossmember formed from the first steel is not, or not only directly, joined to the respective longitudinal beam, also referred to as a cast longitudinal beam or light metal casting longitudinal beam, but the crossmember is connected, in particular directly, to the steel structure, i.e. joined to the steel structure or attached to the steel structure. Furthermore, the steel structure is connected, in particular directly, to the respective longitudinal beam, i.e. joined to the respective longitudinal beam, or attached to the respective longitudinal beam, so that the respective longitudinal beam is connected, i.e. joined, to the crossmember by way of the steel structure, i.e. by way of the intervening steel structure, and is thus linked to the crossmember. In this way, for example the respective longitudinal beam is not, or not only directly, connected to the crossmember, but the respective longitudinal beam is connected to the crossmember by way of the steel structure. By using the steel structure, i.e. by using the second steel which is different from the light metal alloy from which the longitudinal beams are formed and which is different from the first steel, a particularly advantageous, and in particular adequately strong, connection between the steel structure and the crossmember, as well as a particularly advantageous, and in particular adequately strong, connection between the steel structure and the respective longitudinal beam, can be guaranteed, so that the longitudinal beams can overall be advantageously linked to the crossmember by way of the steel structure. The second steel herein can be an advantageously strong material, i.e. a material having an advantageously high tensile strength, wherein the second steel is however preferably of lesser strength than the first steel, i.e. has a lower strength, or tensile strength, in comparison to the first steel. In this way, an advantageous behavior in the event of an accident can be implemented in a weight-effective manner. It is furthermore possible to not use the steel structure, or to not only use the latter, as a simple adapter, in order to bypass the above-described set of joining issues when joining the respective longitudinal beam, or the light metal alloy formed as a light metal casting alloy, directly to the crossmember, or to the first steel, i.e. to solve this set of joining issues; instead, the steel structure can be used or function as a reinforcement structure or reinforcement component, in particular in such a manner that the steel structure, conjointly with the longitudinal beams formed as cast longitudinal beams, forms a common, advantageously stable load path by way of which loads caused by an accident, in particular during an impingement by a force caused by an accident, can be particularly advantageously guided, and in particular kept away from the above-mentioned region, or be guided around the region.

Because the respective longitudinal beam is produced by casting, the respective longitudinal beam is a casting, wherein the casting process by way of which the respective longitudinal beam is produced is a first production technology, or a first production method. The crossmember and, for example, the steel structure are produced by forming, for example, wherein the forming is a second production technology, or a second production method, which is different from the casting process. The invention makes it possible to cleverly combine the two production technologies with one another, whereby any potential disadvantage resulting from the lower tensile strength of the second steel in comparison to that of the first steel can at least be compensated for by using the crossmember as well as the steel structure and the longitudinal beams. Because the light metal alloy as well as the first steel and the second steel are used in the body structure according to the invention, the body structure according to the invention is a hybrid component, so to speak, consequently a hybrid structure by way of which a particularly advantageous behavior in the event of an accident can be implemented. The longitudinal beams herein are castings, consequently cast components, which-in particular due to a casting-specific freedom of design which is in particular greater in comparison to that of sheet metal components-are capable of distributing loads, which are caused by an accident for example and are to be absorbed, particularly advantageously in particular at all contact points with the sheet metal structure, so as thereby to avoid excessive local load peaks in the event of an accident, for example. It is provided, for example, that the cast components contact, consequently touch, in particular directly, the steel structure at the mentioned contact points of the cast components with the steel structure, the latter being formed or functioning in particular as a reinforcement component. In particular, a first one of the contact points coincides with the first joining point, and a second one of the contact points coincides with the second joining point, for example.

In order to be able to implement a particularly advantageous behavior in the event of an accident in a particularly weight-effective manner, it is provided in one embodiment of the invention that the respective longitudinal beam is formed as a respective light metal die casting. In other words, the respective longitudinal beam is produced by die casting, i.e. by a die casting method, so that the above-mentioned casting by way of which the respective longitudinal beam is produced is preferably die casting, i.e. a die casting process, or a die casting method.

A further embodiment is distinguished in that the respective longitudinal beam is formed as a respective aluminum casting, in particular as a respective aluminum die casting, so that the respective longitudinal beam is preferably a cast aluminum longitudinal beam, in particular a die-cast aluminum longitudinal beam. The above-mentioned light metal is thus preferably aluminum. In other words, the above-mentioned light metal alloy is, for example, an aluminum alloy, in particular a cast aluminum alloy. The respective longitudinal beam is thus preferably produced by aluminum casting, in particular by aluminum die casting. As a result, loads caused by an accident can be particularly advantageously guided, in particular owing to the fact that a particularly advantageous load path through the respective longitudinal beam can be formed.

In order to advantageously protect the above-mentioned region and thus the construction element which is able to be disposed or is disposed in the region, and to in this way be able to implement a particularly positive behavior in the event of an accident, it is provided in a further design embodiment of the invention that the crossmember is formed as a sheet steel part, in particular as a formed sheet steel part. In other words, the crossmember is preferably formed from a sheet steel so that the first material is preferably a sheet steel. The crossmember is most preferably produced by forming, in particular by deep drawing, so that the crossmember is a formed part. Owing to this fact, a particularly high degree of stiffness of the crossmember can be implemented in such a way that a particularly advantageous side impact protection can in particular be implemented. For example in the event of a side impact, the crossmember makes it possible in particular to avoid excessive intrusions into the mentioned region, or when viewed in the vehicle transverse direction to achieve an advantageously high degree of stability, or stiffness, of the body structure.

In order to be able to link the longitudinal beams to the crossmember in a particularly advantageous manner and to thus be able to implement overall a particularly high degree of stability or stiffness of the body structure, it is provided in a further embodiment of the invention that the steel structure is formed from sheet steel, in particular from unformed sheet steel. In other words: the second steel is preferably a sheet steel, in particular a formed sheet steel.

In a further, particularly advantageous embodiment of the invention, the first steel is a high-tensile steel having a tensile strength of more than 700 megapascal, in particular having a tensile strength of more than 1000 megapascal. Owing to this fact, the crossmember has a particularly high strength, in particular tensile strength, so that a particularly high degree of stiffness and thus stability of the body structure can be implemented overall. For example, the first steel can in particular be a dual-phase steel, which is also referred to as DP steel. As is well known, the dual-phase steels such as the TRIP steels and the complex-phase steels are members of the multi-phase steels. It is furthermore contemplated that the first steel is a complex-phase steel which is also referred to as CP steel. In comparison to WP steels, CP steels have significantly higher elongation limits, in particular at an identical tensile strength. One of the dual-phase steels is labeled DP 500, for example. One of the complex-phase steels is labeled CP 800, for example. It is furthermore contemplated, for example, that the first steel is a TRIP steel or a residual austenite steel, wherein the residual austenite steel is also referred to as RA steel. TRIP (Transformation Induced Plasticity) steels display an extreme cold fastening, or an extreme cold fastening capability. This has the advantage of an advantageous forming capability, in particular in conjunction with a high final strength of the component. One of the TRIP steels is labeled TRIP 700, for example. Therefore, the first steel can be a martensite-phase steel, for example, which is also referred to as MS steel. Martensite-phase steels have a high basic strength and are particularly advantageously suitable as side impact beams. One of the martensite-phase steels is labeled MS-W 1000, for example.

In order to be able to implement a particularly high strength of the crossmember and thus a particularly high degree of stiffness of the body structure and consequently an advantageous behavior in the event of an accident, it is provided in a further design embodiment of the invention that the first steel is a press-hardened steel. In other words: the crossmember is thus preferably press-hardened, i.e. hardened by press hardening.

In order to be able to particularly advantageously link the steel structure, in particular directly, to the crossmember as well as, in particular directly, to the respective longitudinal beam, so that the longitudinal beams can consequently be particularly advantageously connected to one another by way of the steel structure and the crossmember, it is provided in a further design embodiment of the invention that the second steel is a steel having a tensile strength of less than 500 megapascal and more than 300 megapascal, in particular more than 400 megapascal.

In order to be able to link the longitudinal beams particularly advantageously and in a weight-effective manner to the crossmember, and thus to be able to implement a particularly advantageous behavior of the body structure in the event of an accident in a particularly weight-effective manner, it is provided in a further embodiment of the invention that the steel structure has a first intermediate component which is assigned to the first longitudinal beam, is formed from the second steel, and is, for example, a first one of the above-mentioned parts of the steel structure. The first intermediate component is formed separately from the crossmember and separately from the longitudinal beams. Moreover, the first intermediate component is in particular directly connected to the first longitudinal beam. Moreover, the first intermediate component is in particular directly connected to the crossmember. For example, the first intermediate component is in particular directly connected to the first longitudinal beam at the first joining point, and the first intermediate component is in particular directly connected to the crossmember at the third joining point, for example.

The body structure here has a second intermediate component which is assigned to the second longitudinal beam and is formed from the second steel. The second intermediate component is formed separately from the crossmember, separately from the longitudinal beams and separately from the first intermediate component. Moreover, the second intermediate component is in particular directly connected to the second longitudinal beam, and the second intermediate component is moreover in particular directly connected to the crossmember. For example, the second intermediate component is in particular directly connected to the second longitudinal beam at the second joining point. It is furthermore contemplated that the second intermediate component is in particular directly connected to the crossmember at the fourth joining point.

In order to be able to implement at least one particularly advantageous load path and thus a particularly advantageous behavior in the event of an accident, it is provided in a further embodiment of the invention that a respective longitudinal region, configured in particular as a respective end region of the respective longitudinal beam, of the respective longitudinal beam is received in the steel structure, in particular in the respectively assigned intermediate component, and is thus disposed in an interior of the steel structure. It is particularly contemplated here that the respective longitudinal region, and thus the respective longitudinal beam, is connected to the steel structure within the steel structure. In other words: the respective longitudinal region of the respective longitudinal beam is preferably received in a respective, corresponding receptacle of the steel structure, as a result of which the respective longitudinal region is disposed in the steel structure. It is preferably provided herein that the respective longitudinal region, and thus the respective longitudinal beam, is in particular directly connected to the steel structure in the receptacle. Because the respective longitudinal region of the respective longitudinal beam is disposed in the steel structure, consequently in the respective receptacle, the steel structure encases or clasps the respective longitudinal region, for example, so that a respective casing, in particular clasp, for example, of the respective end region is formed by the steel structure, so to speak. Owing to this fact, a particularly advantageous linking of the longitudinal beams to the steel structure can be implemented. Moreover, it is possible to be able to link the steel structure in a particularly advantageous manner to surrounding or adjacent load paths, i.e. for example to adjacent or surrounding further components of the body structure, in particular by welding and most particularly by spot welding, i.e. by welded connections, in particular by spot-welded connections, as a result of which a particularly advantageous behavior in the event of an accident can be implemented.

In order to be able to keep the weight of the body structure particularly low, it is provided in a further design embodiment of the invention that the longitudinal beams are formed as components that are formed separately from one another and are connected to one another at least by way of the steel structure and the crossmember.

In order to be able to implement a particularly high degree of stiffness of the body structure, it is alternatively provided that the longitudinal beams are integrally formed and as a result formed by a single piece, the latter also being referred to as a monobloc, wherein the piece is produced by the above-mentioned casting, in particular die casting, process. The piece here also has at least one second crossmember, so that the second crossmember is integrally formed with the longitudinal beams. In other words: the longitudinal beams and the second crossmember are formed by the single common piece, consequently by the monobloc. This is understood to mean that the longitudinal beams and the second crossmember are not formed as components which are formed separately from one another and connected to one another, but the longitudinal beams and the second crossmember are formed from a single piece. The second longitudinal beam has a direction of longitudinal extent which extends at least substantially parallel to the vehicle transverse direction. For example, the direction of longitudinal extent of the second longitudinal beam coincides with the direction of longitudinal extent of the first longitudinal beam, or the directions of longitudinal extent of the first crossmember and of the second crossmember are in particular spaced apart in the vehicle longitudinal direction and extend so as to be at least substantially mutually parallel.

It is contemplated that the first longitudinal beam and the second longitudinal beam are disposed successively in the vehicle longitudinal direction, in particular in such a manner that the first longitudinal beam is disposed outside the second longitudinal beam, and the second longitudinal beam is disposed outside the first longitudinal beam. However, it is furthermore contemplated, for example, that the first longitudinal beam is disposed, i.e. received, in the second longitudinal beam, so that the second longitudinal beam surrounds, encases or encompasses the first longitudinal beam, so to speak, for example.

Finally, in order to implement a particularly positive behavior in the event of an accident it has been demonstrated to be particularly advantageous when the body structure is designed as a rear vehicle structure for a rear of the body. It is thus preferably provided that the body structure in the completely built state of the passenger motor car is disposed on the rear of the body, and thus on the rear of the passenger motor car.

A second aspect of the invention relates to an in particular unitary body for a passenger motor car, wherein the body has a body structure according to the first aspect of the invention. Advantages and advantageous design embodiments of the first aspect of the invention are to be considered advantages and advantageous design embodiments of the second aspect of the invention, and vice versa.

A third aspect of the invention relates to a passenger motor car which is also referred to as a vehicle and which has a body which is in particular formed as a unitary body according to the second aspect of the invention. Advantages and advantageous design embodiments of the first aspect and of the second aspect of the invention are to be considered advantages and advantageous design embodiments of the third aspect of the invention, and vice versa.

Further details of the invention are derived from the description hereunder of a preferred exemplary embodiment with the appended drawings.

### BRIEF DESCRIPTION OF THE DRAWINGS

FIG. 1 is a partial, schematic, lower view of a body structure, formed as a rear vehicle structure, for a unitary body of a passenger motor car;

FIG. 2 is a further partial, schematic, lower view of the body structure;

FIG. 3 is a schematic cross-sectional view of the body structure along a section line A-A shown in FIG. 2; and

FIG. 4 is a partial, schematic, perspective view of the body structure.

Identical or functionally equivalent elements are provided with the same reference signs in the FIGS.

### DETAILED DESCRIPTION OF THE DRAWINGS

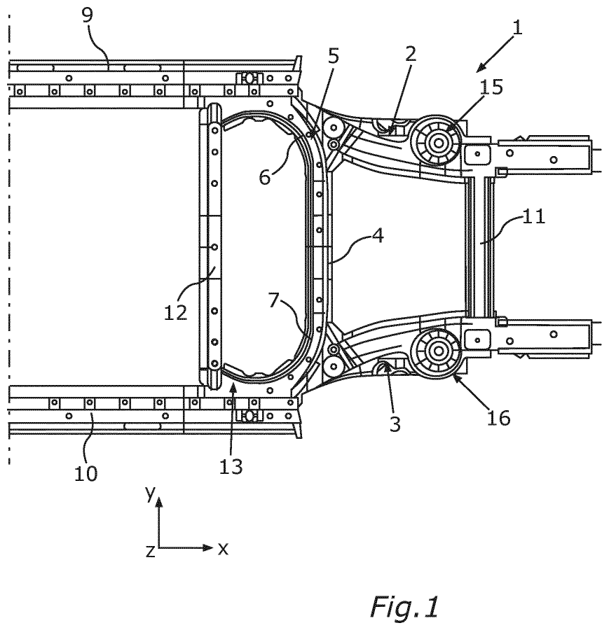

FIG. 1 shows in a schematic lower view a body structure 1 for a unitary body of a passenger motor car, also referred to as a vehicle, the vehicle longitudinal direction of the latter being denoted by x in FIG. 1. The body structure 1 has two longitudinal beams 2 and 3 which are mutually spaced apart in the vehicle transverse direction of the passenger motor car, wherein the vehicle transverse direction is denoted by y in FIG. 1. In particular, the longitudinal beams 2 and 3 are disposed at the same height in the vehicle height direction of the passenger motor car, the vehicle height direction of the latter being denoted by z in FIG. 1. In the exemplary embodiment shown in FIG. 1, the longitudinal beams 2 and 3 are formed as die-cast aluminum longitudinal beams, i.e. as aluminum die castings. This means that the respective longitudinal beams 2, 3 are produced by die casting, i.e. by a die casting method, from an aluminum alloy, i.e. from a cast aluminum alloy and in particular here from a die-cast aluminum alloy. The longitudinal beams 2 and 3 here are produced from the same aluminum alloy. The aluminum alloy is a light metal alloy, as a result of which the respective weight of the respective longitudinal beam 2, 3 can be kept particularly low.

The body structure 1 has a first crossmember 4 which is formed from a first steel. In the exemplary embodiment shown in FIG. 1, the first steel is a press-hardened high-tensile steel, the tensile strength thereof, also referred to as the first tensile strength, being more than 700 megapascal. The first tensile strength is in particular at least or exactly 1000 megapascal. The first tensile strength is most preferably more than 1000 megapascal. Furthermore, the first steel is a sheet steel, so that the crossmember 4 is formed as a sheet steel part. The crossmember 4 is in particular formed, so that the crossmember 4 is most preferably a formed sheet steel part. The crossmember 4 is formed separately from the longitudinal beams 2 and 3, and at least or presently exclusively connected indirectly to the longitudinal beams 2 and 3 in such a way that the longitudinal beams 2 and 3 are connected to one another by way of the crossmember 4.

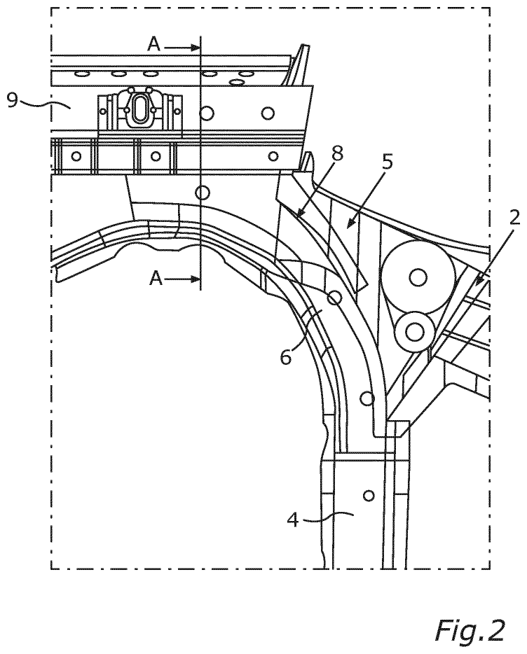

It can be particularly readily seen, when viewing FIGS. 2 to 4 in combination, that the body structure 1 moreover has a steel structure 5 which is formed from a second steel, different from the first steel, the tensile strength of this second steel, also referred to as the second tensile strength, being less than the tensile strength of the first steel. The second steel is thus a material different from the first steel. The first steel is a material which is different from the aluminum alloy from which the longitudinal beams 2 and 3 are formed, and the second steel is a material which is different from the aluminum alloy. The steel structure 5 is formed separately from the crossmember 4 and separately from the longitudinal beams 2 and 3, and connected, in particular directly, to the longitudinal beams 2 and 3, and connected, in particular directly, to the crossmember 4, as a result of which the respective longitudinal beam 2, 3 is in particular directly connected to the steel structure 5. In this way, the longitudinal beams 2 and 3 are connected to one another by way of the steel structure 5 and by way of the crossmember 4.

In the exemplary embodiment shown in the FIGS., the second steel is a sheet steel, in particular a formed sheet steel, so that the steel structure 5 is formed as a sheet steel, in particular as a formed sheet steel. For example, the second tensile strength is less than 500 megapascal and more than 300 megapascal. In particular, the second tensile strength is less than 500 megapascal and more than 400 megapascal. Owing to this fact, the steel structure 5 can be linked particularly advantageously to the longitudinal beams 2 and 3 as well as particularly advantageously to the crossmember 4, so that a particularly positive behavior of the body structure 1 in the event of an accident can be implemented in a particularly weight-effective manner.

In the exemplary embodiment shown in the FIGS., the steel structure 5 is formed in multiple parts. The steel structure 5 here has a first intermediate component 6, also referred to as the first part of the steel structure 5, which is assigned to the longitudinal beam 2 and formed from the second steel. The longitudinal beam 2 is also referred to as the first longitudinal beam. The first intermediate component 6 is formed separately from the crossmember 4 and separately from the longitudinal beams 2 and 3. Moreover, the first intermediate component 6 is in particular directly connected to the longitudinal beam 2. Furthermore, the intermediate component 6 is in particular directly connected to the crossmember 4. For example, the intermediate component 6 is in particular riveted to the longitudinal beam 2, and thus connected in particular directly to the longitudinal beam 2 by riveting. Alternatively or additionally, the intermediate component 6 is in particular directly welded to the crossmember 4, for example, and thus connected in particular directly to the crossmember 4 by welding. The steel structure 5 moreover has a second intermediate component 7 which is assigned to the longitudinal beam 3 and is a second part of the steel structure 5. The intermediate component 7 is formed from the second steel. The intermediate component 7 is formed separately from the crossmember 4, separately from the longitudinal beams 2 and 3, and separately from the first intermediate component 6. Furthermore, the intermediate component 7 is in particular directly connected to the longitudinal beam 3, the latter also being referred to as the second longitudinal beam. Furthermore, the intermediate component 7 is in particular directly connected to the crossmember 4. For example, the intermediate component 7 is in particular directly riveted to the longitudinal beam 3 and thus connected in particular directly to the longitudinal beam 3 by riveting. Alternatively or additionally, the intermediate component 7 is in particular directly welded to the crossmember 4, for example, and thus connected in particular directly to the crossmember 4 by welding.

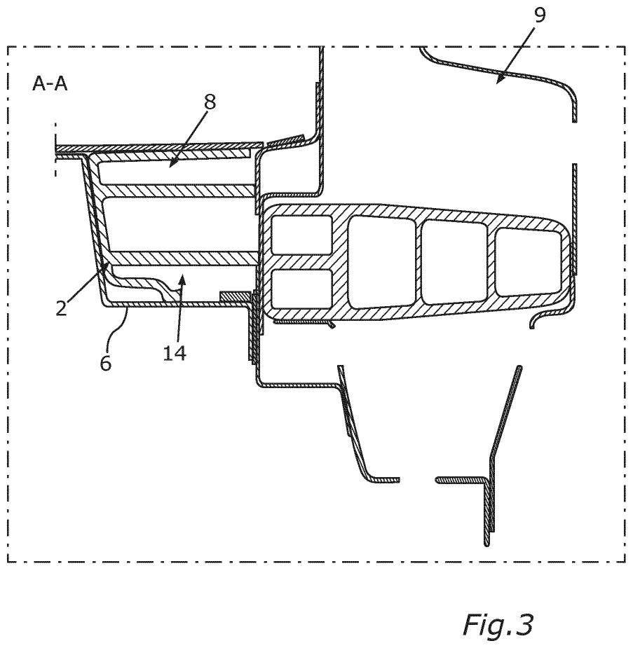

Using the example of the intermediate component 6 and the longitudinal beam 2, it can be seen from FIGS. 2, 3 that the respective intermediate component 6, 7 has a receptacle 14 in which a respective longitudinal region, formed as an end region 8, of the respective longitudinal beam 2, 3 is disposed, whereby the intermediate component 6 is illustrated to be transparent in FIG. 2. Owing to this fact, the respective intermediate component 6, 7 encases or clasps the respective end region 8 of the respective longitudinal beam 2, 3. It is provided in particular that the respective longitudinal beam 2, 3 is in particular directly connected to the respective intermediate component 6, 7 in the respective receptacle 14 of the respective intermediate component 6, 7. The receptacle 14 of the intermediate component 6 can be particularly well seen in FIG. 3.

In the exemplary embodiment shown in the Figs., the longitudinal beams 2 and 3 are components which are formed separately from one another and connected indirectly to one another, being connected to one another by way of the steel structure 5 and the crossmember 4.

It can be particularly well seen in FIG. 1 that the body structure 1 has lateral longitudinal beams 9 and 10 which are provided in addition to the longitudinal beams 2 and 3 and which are also referred to as side sills. The lateral longitudinal beams 9 and 10, which are also referred to as second longitudinal beams, are mutually spaced apart in the vehicle transverse direction. The lateral longitudinal beam 9 is assigned to the intermediate component 6 and connected to the longitudinal beam 2 at least or exclusively by way of the intermediate component 6, in particular owing to the fact that the intermediate component 6 is in particular directly connected to the longitudinal beam 9. The same applies in an analogous manner to the lateral longitudinal beam 10 and the longitudinal beam 3. The lateral longitudinal beam 10 is connected to the longitudinal beam 3 at least or exclusively by way of the intermediate component 7, in particular owing to the fact that the intermediate component 7 is in particular directly connected to the lateral longitudinal beam 10. In this way, the lateral longitudinal beam 10 is assigned to the intermediate component 7. When viewed in the vehicle transverse direction, it can be seen that the lateral longitudinal beams 9 and 10 are disposed further outside than the rear longitudinal beams 2 and 3, the latter being disposed further to the rear than the lateral longitudinal beams 9 and 10, when viewed in the vehicle longitudinal direction. This is understood to mean in particular that the lateral longitudinal beams 9 and 10 adjoin at least respective sub-regions of the longitudinal beams 2 and 3 toward the front in the vehicle longitudinal direction, and thus in the direction of a front of the passenger motor car.

In the exemplary embodiment shown in the FIGS., the crossmember 4 is designed in a shell construction, for example, so that the crossmember 4 has, for example, at least or exactly two shell elements which are in particular directly connected to one another, thus being assembled while forming the crossmember 4. The body structure 1 here has a second crossmember 11, which is provided in addition to the crossmember 4 and in the vehicle longitudinal direction is disposed further to the rear, and thus further in the direction of a rear of the passenger motor car, than the crossmember 4. The longitudinal beams 2 and 3 here are connected to one another by way of the crossmember 11, for example, in particular in such a manner that the crossmember 11 is linked, i.e. joined, at least indirectly or preferably directly to the longitudinal beams 2 and 3. Furthermore, the body structure 1 has a third crossmember 12 which is provided in addition to the crossmembers 4 and 11, by way of which crossmember 12 the intermediate components 6 and 7, and/or the lateral longitudinal beams 9 and 10, are connected to one another, for example. For this purpose, the crossmember 12 is linked in particular directly to the lateral longitudinal beams 9 and 10, for example. Alternatively or additionally, the crossmember 12 is linked in particular directly to the intermediate components 6 and 7, for example. It is provided in particular that the crossmember 12 is formed separately from the lateral longitudinal beams 9 and 10, and separately from the intermediate components 6 and 7, and also separately from the crossmember 4 and separately from the crossmember 11. It is furthermore preferably provided that the crossmember 11 is formed separately from the longitudinal beams 2 and 3, and separately from the crossmember 4, and separately from the crossmember 12, and separately from the intermediate components 6 and 7 and also separately from the lateral longitudinal beams 9 and 10. Furthermore, the crossmember 12 is formed separately from the longitudinal beams 2 and 3, for example.

In the completely built state of the passenger motor car, a rear subframe, which is formed separately from the unitary body, is held on, i.e. fastened to, the body structure 1, for example, in particular in such a manner that the rear subframe is fastened in particular directly to the crossmember 4 and in particular directly to the crossmember 11. While the rear subframe is formed separately from the body and held on the body in such a way that the rear subframe is not a constituent part of the unitary body, the body structure 1 is a fixed constituent part of the unitary body and thus fixedly connected to the remaining part of the unitary body, i.e. so as not to be able to be released in a non-destructive manner.

The crossmember 12 is, for example, designed as a heel plate, or is also referred to as a heel plate, wherein a main floor of the body, which is not illustrated in the FIGS., in the vehicle longitudinal direction ends toward the rear at the heel plate, for example. It is furthermore contemplated that the crossmember 11 and/or the crossmember 12 are designed in a shell construction. It is thus contemplated in particular that the crossmember 11, 12 has at least or exactly two shell elements which can be in particular directly connected to one another and thus can be assembled while forming the respective crossmember 11, 12. It is contemplated in particular that the respective crossmember 11, 12 is designed and/or formed from sheet metal, in particular from a sheet steel. Furthermore, it is contemplated that the respective lateral longitudinal beam 9, 10 is designed and/or formed from sheet metal, in particular from sheet steel. It is furthermore contemplated that the respective longitudinal beam 9, 10 is designed in a shell construction, so that the respective lateral longitudinal beam 9, 10 for example has at least or exactly two shell elements which are formed separately from one another and are in particular directly connected to one another, and thus assembled while forming the respective lateral longitudinal beam 9, 10.

The crossmember 12 can be formed from the first steel from which the crossmember 4 is formed. It is furthermore contemplated that the crossmember 12 is formed from a third steel, different from the first steel, wherein the third steel can correspond to the second steel, for example, or the third steel is a third steel which is different from the first steel and from the second steel.

It can be particularly readily seen in FIG. 1 that the respective intermediate component 6, 7 is designed to be at least substantially C-shaped, wherein the at least substantially C-shaped intermediate components 6 and 7 are complemented by the crossmembers 4 and 12 so as to form an at least substantially annular, in particular closed, structure 13. This means that the presently closed annular structure 13 comprises the intermediate components 6 and 7 and the crossmembers 4 and 12, and is formed in particular in that the crossmember 4 is in particular directly linked to the intermediate components 6 and 7, and the crossmember 12 is in particular directly linked to the intermediate components 6 and 7. It can furthermore be seen in FIG. 1 that the annular structure 13 in the vehicle transverse direction toward the outside is in each case at least partially overlapped by the lateral longitudinal beams 9 and 10 on both sides in such a way that the annular structure 13, when viewed in the vehicle transverse direction, is at least partially, in particular at least largely or completely, disposed between the lateral longitudinal beams 9 and 10. The annular structure 13 is, or functions as, a reinforcement frame in order to be able to implement a particularly advantageous behavior of the body structure 1 in the event of an accident, in particular in the event of a side impact. It is provided here that the high-tensile and preferably press-hardened crossmember 4, or the reinforcement frame, is not joined directly to the longitudinal beams 2 and 3 that are formed as die-cast longitudinal beams, but is connected to the intermediate components 6 and 7 that are formed or function as reinforcement components and then in turn are in particular directly joined to the longitudinal beams 2 and 3 that are formed as die-cast components. The respective intermediate component 6, 7 formed as a steel component is not, or not only, a simple adapter component for linking the longitudinal beams 2 and 3 to the crossmember 4 by way of the intermediate components 6 and 7, but the respective intermediate component 6, 7 is or functions as a reinforcement component, in particular in such a manner that the respective intermediate component 6, 7, conjointly with the respective longitudinal beam 2, 3, formed as a die-cast aluminum longitudinal beam, forms a common, advantageously stable load path.

It can be seen in FIG. 3 that owing to the fact that the respective end region 8 of the respective longitudinal beam 2, 3 is disposed in the respective receptacle of the respective intermediate component 6, 7, the receptacle being denoted by the reference sign 14 in FIG. 3, a casing, in particular clasp, of the respective end region 8 is achieved by the respective intermediate component 6, 7. In the process, the respective intermediate component 6, 7 engages across and below the respective end region 8 in such a way that the respective intermediate component 6, 7 is in particular directly connected to the respective lateral longitudinal beam 9, 10 disposed on the respective side of the respective intermediate component 6, 7. This is implemented in particular in such a manner that the respective intermediate component 6, 7 is in particular directly welded to the respective lateral longitudinal beam 9, 10, in particular by spot welding, as a result of which a particularly positive behavior in the event of an accident can be guaranteed. The lateral longitudinal beams 9 and 10 are components which are contiguous to the intermediate components 6 and 7, or components which surround the intermediate components 6, 7, and can form or provide advantageous load paths. The intermediate components 6 and 7 are thus in particular directly linked to the surrounding load paths, in particular those formed by the lateral longitudinal beams 9 and 10. The respective longitudinal beam 2, 3, formed as a cast component, in the interior of the respective intermediate component 6, 7 acting or functioning as a reinforcement component, by virtue of a larger casting-specific freedom of design compared to sheet metal components, is capable of advantageously distributing loads to be absorbed to all contact points with the respective intermediate component 6, 7 formed or functioning as a reinforcement component, so as hereby to be able to avoid local load peaks in the event of an accident.

For example, the respective lateral longitudinal beam 9, 10 is formed from a high-tensile steel, the tensile strength thereof, also referred to as a third tensile strength, being less than the first tensile strength. For example, the third tensile strength corresponds to the second tensile strength, or the third tensile strength is lower or greater than the second tensile strength.

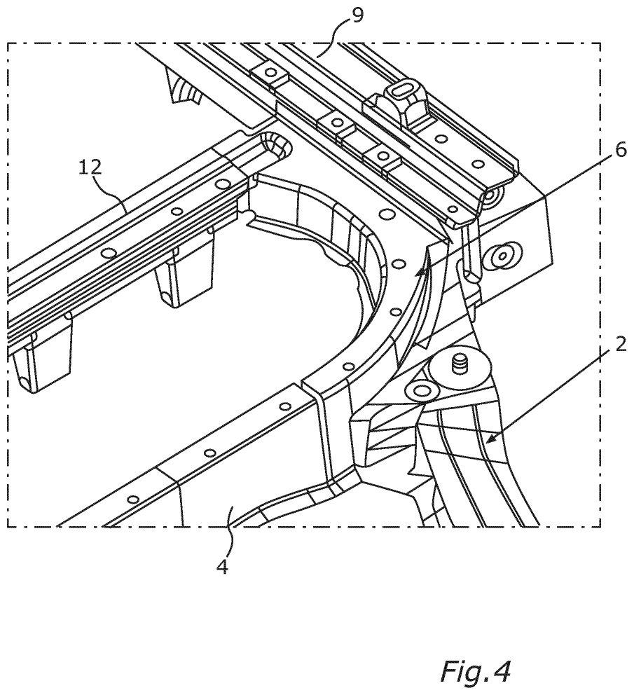

The presently direct link between the intermediate component 6 and the associated lateral longitudinal beam 9, and the associated longitudinal beam 2, and the crossmember 4 and the crossmember 12, can be particularly readily seen in FIG. 4. It can furthermore be seen in FIG. 1 that the respective longitudinal beam 2, 3 has a respective support region 15, 16, for example, on which in particular a spring and/or damper element of a running gear of the passenger motor car is able to be supported, or is supported, toward the top in the vehicle height direction. In this way, the spring and/or damper element is on one side, in particular at one end, able to be supported toward the top in the vehicle height direction on the respective support region 15, 16, for example, and on the other side, in particular at the other end, the respective spring and/or damper element is linked to the mentioned rear subframe, for example.

In the exemplary embodiment shown in the Figs., there is neither a direct connection between the crossmember 4 and the longitudinal beam 2, nor a direct connection between the crossmember 4 and the longitudinal beam 3, so that the crossmember 4 in the exemplary embodiment shown in the Figs. is connected to the longitudinal beam 2 exclusively by way of the intervening steel structure 5, and connected to the longitudinal beam 3 exclusively by way of the intervening steel structure 5.

In an embodiment not shown in the FIGS., it is contemplated that the longitudinal beams 2 and 3 are integrally formed and thus formed by a single piece, i.e. formed from a single piece, which is also referred to as a monobloc. For example, the monobloc has an additional, further crossmember which is thus formed integrally with the longitudinal beams 2 and 3. It is contemplated here that the crossmember 4 is disposed in the further crossmember, or the further crossmember is disposed in the crossmember 4. In this embodiment it is in particular contemplated that the crossmember 4 is connected directly to the longitudinal beam 2 and directly to the longitudinal beam 3, wherein the crossmember 4 is preferably also connected directly to the intermediate component 6 and directly to the intermediate component 7.

### LIST OF REFERENCE SIGNS

Body structure
Longitudinal beam
Longitudinal beam
Crossmember
Steel structure
Intermediate component
Intermediate component
End region
Lateral longitudinal beam
Lateral longitudinal beam
Second crossmember
Third crossmember
Structure
Receptacle
Support region
Support region
x Vehicle longitudinal direction
y Vehicle transverse direction
z Vehicle height direction

1.-15. (canceled)

16. A body structure for a body of a passenger motor car, comprising:
two longitudinal beams which are mutually spaced apart in a vehicle transverse direction and formed as light metal castings;
at least one crossmember which is formed from a first steel; and
a steel structure which is formed from a second steel different from the first steel, wherein
the steel structure is connected to the respective longitudinal beams and to the crossmember, wherein each respective one of the two longitudinal beams is connected to the crossmember by way of the steel structure.

17. The body structure according to claim 16, wherein
the two longitudinal beams are formed as respective light metal die castings.

18. The body structure according to claim 17, wherein
the respective light metal die castings are aluminum die castings.

19. The body structure according to claim 16, wherein
the crossmember is formed as a sheet steel part.

20. The body structure according to claim 16, wherein
the steel structure is formed from sheet steel.

21. The body structure according to claim 16, wherein
the first steel is a high-tensile steel having a tensile strength of more than 700 MPa.

22. The body structure according to claim 16, wherein
the first steel is a press-hardened steel.

23. The body structure according to claim 16, wherein
the second steel is a steel having a tensile strength of less than 500 MPa and more than 300 MPa.

24. The body structure according to claim 16, wherein the steel structure comprises:
a first intermediate component which is assigned to a first one of the two longitudinal beams, is formed from the second steel, is formed separately from the crossmember and separately from the two longitudinal beams, and is connected to the first longitudinal beam and to the crossmember, and
a second intermediate component which is assigned to the second one of the two longitudinal beams, is formed from the second steel, is formed separately from the crossmember, separately from the two longitudinal beams, and separately from the first intermediate component, and is connected to the second longitudinal beam and to the crossmember.

25. The body structure according to claim 16, wherein
a respective longitudinal end region of a respective longitudinal beam is received in the steel structure.

26. The body structure according to claim 16, wherein
the two longitudinal beams are components that are formed separately from one another and are connected to one another at least by way of the steel structure and the crossmember.

27. The body structure according to claim 16, wherein
the two longitudinal beams are integrally formed as a single piece which also has at least one second crossmember.

28. The body structure according to claim 16, wherein
the body structure is a rear vehicle structure for a rear of the body.

29. A body for a passenger motor car comprising a body structure according to claim 16.

30. A passenger motor car comprising a body according to claim 29.

31. A method of forming a body structure for a body of a passenger motor car, the method comprising:
casting, from a light metal, two longitudinal beams that are configured to be spaced apart from one another in a vehicle transverse direction;
forming, from a first steel, at least one crossmember of the body structure;
forming, from a second steel different from the first steel, a steel structure; and
connecting, via the steel structure, the two longitudinal beams and the crossmember.

32. The method according to claim 31, wherein the steel structure is formed by:
a first intermediate component which is assigned to a first one of the two longitudinal beams, is formed from the second steel, is formed separately from the crossmember and separately from the two longitudinal beams, and is connected to the first longitudinal beam and to the crossmember, and
a second intermediate component which is assigned to the second one of the two longitudinal beams, is formed from the second steel, is formed separately from the crossmember, separately from the two longitudinal beams and separately from the first intermediate component, and is connected to the second longitudinal beam and to the crossmember.

33. The method according to claim 31, wherein
the crossmember is formed as a sheet steel part, and
the two longitudinal beams are cast of aluminum.

34. The method according to claim 31, wherein
the first steel is a press hardened steel having a tensile strength of more than 700 MPa, and
the second steel has a tensile strength of less than 500 MPa and greater than 300 MPa.
